(19) United States
(12) Patent Application Publication
(10) Pub. No.: US 2025/0005684 A1
(43) Pub. Date: Jan. 2, 2025

(54) SYSTEM, METHOD, AND COMPUTER PROGRAM FOR SOCIAL PLATFORM INFORMATION PRE-PROCESSING

(71) Applicant: RAKUTEN SYMPHONY SINGAPORE PTE. LTD., Capitagreen (SG)

(72) Inventors: Tomoya MURATA, Capitagreen (JP); Sanyam MADAAN, Capitagreen (IN)

(73) Assignee: RAKUTEN SYMPHONY SINGAPORE PTE. LTD., Capitagreen (SG)

(21) Appl. No.: 17/917,178

(22) PCT Filed: May 26, 2022
(86) PCT No.: PCT/US2022/031033

§ 371 Date: Oct. 5, 2022

(51) Int. Cl. G06Q 50/00; G06F 3/0482

(52) U.S. Cl. CPC G06Q 50/01; G06F 3/0482

(57) ABSTRACT

A method for pre-processing information, performed by at least one processor, is provided. The method includes retrieving information from a social platform based on predetermined keywords defined by a system user, obtaining a blacklist of user accounts, the blacklist including user account information and a blacklist reason for adding the user account information to the blacklist; pre-processing the retrieved information, based on the blacklist, determining a sentiment value associated with the pre-processed information and assigning the pre-processed information to a sentiment category based on the sentiment value, and displaying a first graphical user interface (GUI) for receiving user input information to generate a ticket for the pre-processed information. A list of the retrieved information may be displayed, wherein the user accounts included in the blacklist are distinguishably displayed on the GUI.

### FIELD

Embodiments of the present disclosure relate to creating a blacklist and pre-processing information retrieved from a social platform by applying the blacklist to said information. The pre-processing identifies less useful/non-useful information such that said information can be excluded for computing a sentiment category and for taking an action (e.g., creating a ticket) based thereon. Further, the disclosure may provide a system to categorize the pre-processed information so as to present only informative information to the user.

### DESCRIPTION OF RELATED ART

Information (e.g., comments, posts, live feeds, etc.) on social platforms provide important insight for determining users' responses on a specific matter (e.g., satisfaction on a product, urgency on an issue, interest in a new service, etc.). In a related art, service providers/product manufacturers hire analysts to manually monitor and analyze potential problematic information on the social platforms. If potential problematic information is detected, the analysts need to manually review the issue to extract key information, create a ticket for the issue based on the key information, wait for the ticket to be reviewed and assigned to appropriate personnel, and connect an end user who raises the problematic information to a person in charge. Accordingly, related art social platform systems do not have a method for monitoring the social platform information to provide insightful information for ticket creation. In order to monitor information on a social platform accurately and efficiently to appropriately take an action thereto (such as creating a ticket, contacting the customer, etc.), the information provided for processing (e.g., for computing sentiment category, etc.) should be as accurate and precise as possible.

A related art system can categorize (e.g., negative, positive, neutral) the information on a social platform. However, since all the information on the social platform is being monitored by the system, in a case where the information includes non-accurate information (e.g., false information posted by a competitor, spamming message, repeat posting by a same user, same information posted by multiple accounts, etc.), the processing will not be accurate. Further, the amount of non-accurate information may be significant, which will result in unnecessary expending of network resources. Furthermore, it is difficult for a system user to identify, from a significant amount of information, which information is less accurate or is posted by users who which an action needs to be taken carefully.

Thus, there is a need to provide a system for improving and enhancing the performance of such a social platform system. Embodiments of this disclosure provide additional features, such as pre-processing information retrieved from the social platform, to improve and enhance the performance of related art social platform systems.

### SUMMARY

One or more example embodiments of the present disclosure provide an apparatus and method for pre-processing information retrieved from a social platform (or social media platform), to improve and enhance the perform of related art social platform systems.

One or more example embodiments of the present disclosure provide an apparatus and method for manual creation of a blacklist via a graphical user interface (GUI), with and/or without system recommendations (via keyword monitoring, user's history, etc.), and creation of watchlists to filter information, and categorization of the filtered information.

According to embodiments, there is provided a method for pre-processing information from a social platform, performed by at least one processor. The method includes: retrieving information from a social platform based on predetermined keywords defined by a system user; obtaining a blacklist of user accounts, the blacklist including user account information and a blacklist reason for adding the user account information to the blacklist; pre-processing the retrieved information, based on the blacklist; determining a sentiment value associated with the pre-processed information and assigning the pre-processed information to a sentiment category based on the sentiment value; and displaying a first graphical user interface (GUI) for receiving user input information to generate a ticket for the pre-processed information, wherein retrieved information associated with the user account information included in the blacklist are distinguishably displayed.

The method may further include wherein the pre-processing includes: determining, from the retrieved information and based on the blacklist, information associated with a user account included in the blacklist; generating a list presenting the retrieved information, wherein the information associated with the user account included in the blacklist and the information associated with a user account not included in the blacklist are presented in a different manner; receiving a user input for selecting one or more information from the list, wherein the selected information comprises the information associated with the user account included in the blacklist; and filtering out the selected information so as to be excluded from the determining the sentiment value.

The method may further include displaying a second GUI for adding a user account to the blacklist, the second GUI including a first input field for user account information and a second input field for blacklist reason.

The method may further include wherein the first input field is auto-filled.

The method may further include generating a watchlist, determining if a user account is to be included in the watchlist based on a suspect level determined according to an analysis of information posted by the user account to the social platform, and moving the user account from the watchlist to the blacklist based on a user input to move the user account.

The method may further include receiving a user input, via the second GUI, to delete a user account from the blacklist.

The method may further include generating a trash list and adding information determined to be non-informative to the trash list based on a rule set by the system user, wherein the information is added to the trash list based on information previously added to the trash list.

According to embodiments, there is provided an apparatus for pre-processing information from a social platform. The apparatus may include at least one memory storing instructions and at least one processor configured to read the program code and operate as instructed by the program code. The at least one processor is configured to read the program code and operate as instructed by the program code to retrieve information from a social platform based on predetermined keywords defined by a system user; obtain a blacklist of user accounts, the blacklist including user account information and a blacklist reason for adding the user account information to the blacklist; pre-process the retrieved information, based on the blacklist; determining a sentiment value associated with the pre-processed information and assign the pre-processed information to a sentiment category based on the sentiment value; and display first a graphical user interface (GUI) for receiving user input information to generate a ticket for the pre-processed information, wherein retrieved information associated with the user account information included in the blacklist are distinguishably displayed.

The apparatus may further include wherein the at least one processor is configured to read the program code and operate as instructed by the program code to pre-process the retrieved information by: determining, from the retrieved information and based on the blacklist, information associated with a user account included in the blacklist; generating a list presenting the retrieved information, wherein the information associated with the user account included in the blacklist and the information associated with a user account not included in the blacklist are presented in a different manner; receiving a user input for selecting one or more information from the list, wherein the selected information comprises the information associated with the user account included in the blacklist; and filtering out the selected information so as to be excluded from determining the sentiment value.

The apparatus may further include wherein the at least one processor is configured to read the program code and operate as instructed by the program code to display a second GUI for adding a user account to the blacklist, the second GUI including a first input field for user account information and a second input field for blacklist reason.

The apparatus may further include wherein the first input field is auto-filled.

The apparatus may further include wherein the at least one processor is configured to read the program code and operate as instructed by the program code to: generate a watchlist; determine if a user account is to be included in the watchlist based on a suspect level determined according to an analysis of information posted by the user account to the social platform; and move the user account from the watchlist to the blacklist based on a user input to move the user account.

The apparatus may further include wherein the at least one processor is configured to read the program code and operate as instructed by the program code to receive a user input, via the second GUI, to delete a user account from the blacklist.

The apparatus may further include wherein the at least one processor is configured to read the program code and operate as instructed by the program code to generate a trash list and add information determined to be non-informative to the trash list based on a rule set by the system user or information previously added to the trash list.

According to one or more embodiments, there is provided a non-transitory computer-readable medium storing computer code for pre-processing information from a social platform. The computer code may be configured to, when executed by at least one processor of an apparatus, cause the at least one processor to: retrieve information from a social platform based on predetermined keywords defined by a system user; obtain a blacklist of user accounts, the blacklist including user account information and a blacklist reason for adding the user account information to the blacklist; pre-process the retrieved information, based on the blacklist; determine a sentiment value associated with the pre-processed information and assign the pre-processed information to a sentiment category based on the sentiment value; and display a graphical user interface (GUI) for receiving user input information to generate a ticket, wherein retrieved information associated with the user account information included in the blacklist are distinguishably displayed.

The non-transitory computer-readable medium may further include wherein the instructions further cause the at least one processor to pre-process the retrieved information by: determining, from the retrieved information and based on the blacklist, information associated with a user account included in the blacklist; generating a list presenting the retrieved information, wherein the information associated with the user account included in the blacklist and the information associated with a user account not included in the blacklist are presented in a different manner; receiving a user input for selecting one or more information from the list, wherein the selected information comprises the information associated with the user account included in the blacklist; and filtering out the selected information so as to be excluded from the determining the sentiment value.

The non-transitory computer-readable medium wherein the instructions may further cause the at least one processor to display a second GUI for adding a user account to the blacklist, the second GUI including a first input field for user account information and a second input field for blacklist reason.

The non-transitory computer-readable medium wherein the instructions may further cause the at least one processor to delete a user account from the blacklist based on a user input, received via the second GUI, to delete the user account from the blacklist.

The non-transitory computer-readable medium wherein the instructions may further cause the at least one processor to: generate a watchlist; determine if a user account is to be included in the watchlist based on a suspect level determined according to an analysis of information posted by the user account to the social platform; and move the user account from the watchlist to the blacklist based on a user input to move the user account.

The non-transitory computer-readable medium wherein the instructions may further cause the at least one processor to generate a trash list and add information determined to be non-informative to the trash list based on a rule set by the system user or information previously added to the trash list.

Additional aspects will be set forth in part in the description that follows and, in part, will be apparent from the description, or may be realized by practice of the presented embodiments of the disclosure.

### BRIEF DESCRIPTION OF THE DRAWINGS

The above and other aspects, features, and aspects of embodiments of the disclosure will be more apparent from the following description taken in conjunction with the following accompanying drawings.

FIG. 1 is a diagram of devices of a system according to one or more embodiments.

FIG. 2 is a diagram of components of the devices of FIG. 1 according to one or more embodiments.

FIG. 3 is an exemplary diagram of a centralized customer supporting system according to one or more embodiments.

FIG. 4 is an exemplary flowchart illustrating a method for processing information from a social platform according to one or more embodiments.

FIG. 5 is a block diagram of an example of computer code processing information from a social platform according to one or more embodiments.

FIG. 6 is a diagram illustrating a graphical user interface (GUI) according to one or more embodiments.

FIG. 7(A)-(B) are diagrams illustrating another example GUI according to one or more embodiments.

FIG. 8 is a diagram illustrating another example GUI according to one or more embodiments.

FIG. 9 is a diagram illustrating another example GUI according to one or more embodiments.

FIG. 10 is a diagram illustrating another example GUI according to one or more embodiments.

FIG. 11 is a diagram illustrating another example GUI according to one or more embodiments.

FIG. 12 is a diagram illustrating another example GUI according to one or more embodiments.

### DETAILED DESCRIPTION

The present disclosure relates to an information processing system that performs pre-processing of information retrieved from a social platform based on a generated backlist. The blacklist may be created and enhanced in several ways, as exemplarily described below. The system may also categorize the pre-processed information according to user requirements, such that only information of the user's interest is used for further processing. The pre-processing according to embodiments may be implemented to improve the accuracy of information retrieved from a social platform and reduce unnecessary expenditure of network resources.

Embodiments of the present disclosure are described comprehensively with reference to the accompanying drawings. However, the examples of implementations may be implemented in various multiple forms, and the disclosure should not be construed as being limited to the examples described herein. Conversely, the examples of implementations are provided to make the technical solution of the disclosure more comprehensive and complete, and comprehensively convey the idea of the examples of the implementations to a person skilled in the art. The accompanying drawings are merely example illustrations of the disclosure and are not necessarily drawn to scale.

Proposed features discussed below may be used separately or combined in any order. Some block diagrams shown in the accompany drawings are functional entities and do not necessarily correspond to physically or logically independent entities. Further, the embodiments may be implemented by processing circuitry (e.g., one or more processors or one or more integrated circuits) or as computer software using computer-readable instructions and physically stored in one or more computer-readable media, or implemented in different networks and/or processor apparatuses and/or microcontroller apparatuses. In one example, the one or more processors execute computer program code that is stored in a one or more non-transitory computer-readable media.

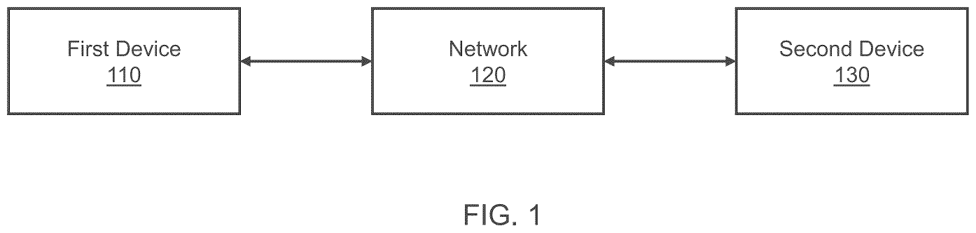

FIG. 1 is a diagram of a system according to an embodiment. FIG. 1 includes a first device 110, a network 120, and a second device 130. The first device 110 and the second device 130 may interconnect via wired connections, wireless connections, or a combination of wired and wireless connections.

The first device 110 may include user devices such as a computing device (e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device.

The second device 130 may include one or more devices. For example, the second device 130 may be a server device, a computing device, or the like.

The network 120 may include one or more wired and/or wireless networks. For example, network 120 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

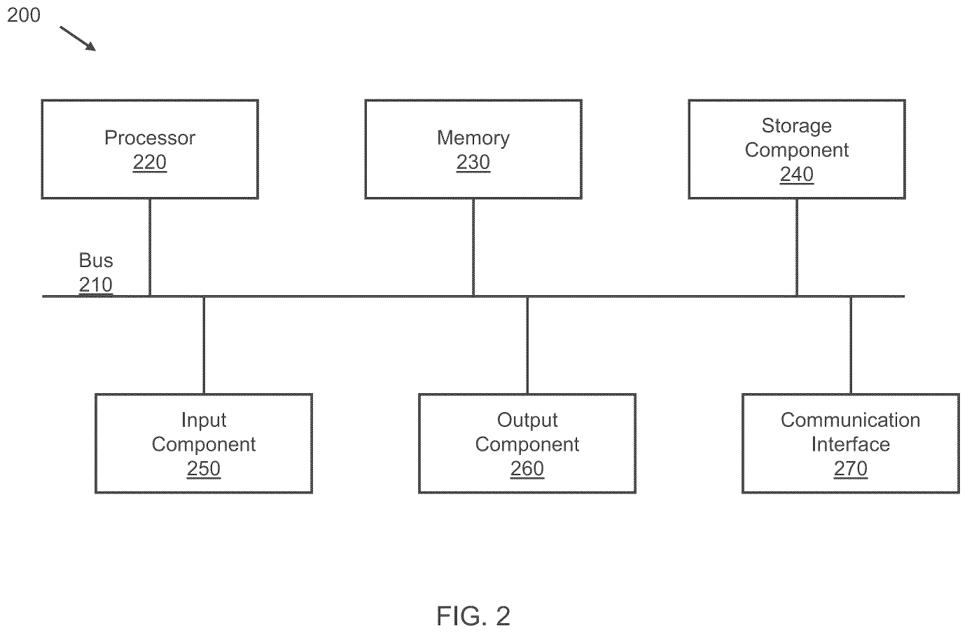

FIG. 2 is a diagram of components of one or more devices of FIG. 1 according to an embodiment. Device 200 may correspond to the first device 110 and/or the second device 130.

As shown in FIG. 2, the device 200 may include a bus 210, a processor 220, a memory 230, a storage component 240, an input component 250, an output component 260, and a communication interface 270.

The bus 210 may include a component that permits communication among the components of the device 200. The processor 220 may be implemented in hardware, software, or a combination of hardware and software. The processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor 220 may include one or more processors capable of being programmed to perform a function.

The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include a component that permits the device 200 to receive information, such as via user input (e.g., a touch screen display, a keyboard, a keypad, a mouse, a button, a switch, and/or a microphone). The input component 250 may include a sensor for sensing information (e.g., a global positioning system (GPS) component, an accelerometer, a gyroscope, and/or an actuator).

The output component 260 may include a component that provides output information from the device 200 (e.g., a display, a speaker, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

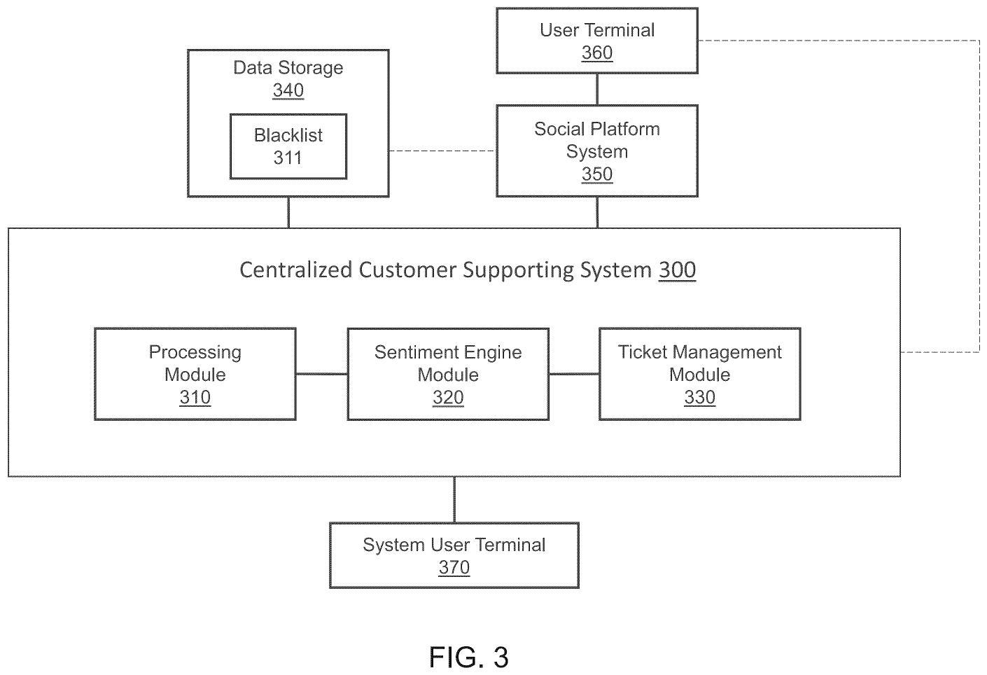

Embodiments of the present disclosure may be performed by an information processing module in a centralized customer supporting system. FIG. 3 is an exemplary diagram of a centralized customer supporting system 300 according to an embodiment. The centralized customer supporting system (“the centralized system” hereinafter) 300 may include a processing module 310, a sentiment engine module 320, and a ticket management module 330. The centralized system 300 may also include or be communicably connected to a data storage 340. Further, the centralized system 300 may be communicably connected to a social platform system 350, e.g., via a network such as the Internet.

The centralized system 300 may correspond to the second device 130 (or one or more server devices) shown in FIG. 1, and the modules (i.e., the processing module 310, the sentiment engine module 320, and the ticket management module 330) of the centralized system 300 may be implemented as software instructions executed by at least one processor 220.

The processing module 310 may provide a graphical user interface (GUI) for creating a blacklist 311 and storing the blacklist 311 into a data storage 340, adding a user account to the blacklist 311, and removing/deleting a user account from the blacklist 311. The processing module 310 performs pre-processing or filtering of the information retrieved from the social platform system 350, based on the blacklist 311. For instance, information associated with a user account(s) included in the blacklist may be distinguished from information associated with a user account(s) not included in the blacklist (e.g., information associated with the user account(s) included in the blacklist and information associated with the user account(s) not included in the blacklist may be presented to a user in a different manner), and information associated with a user account(s) included in the blacklist may be optionally excluded from the information to-be used for the processing of the system (e.g., a system user can select information associated with one or more user accounts included in the blacklist, so that the selected information will be excluded from the information for creating a ticket, etc.). The blacklist 311 may include, for example, at least one of a list of user accounts, posts corresponding to the user accounts, blacklist reason, blacklisted date, blacklisted time, user (e.g., system user account information) that added the blacklisted account or post to the blacklist, etc. The blacklist 311 may be stored in the data storage 340 (e.g., a centralized data center), so that all users (system users) can share and/or use the blacklist 311 and also contribute to the blacklist 311. The data storage 340 may be internal or external to the centralized system 300 and may be similar to or different from the storage component 240 of FIG. 2. In some embodiments, the data storage 340 comprises multiple data storages.

An end user, for example, may access the social platform system 350 via a user terminal 360 and post information on one or more social platforms included in the social platform system 350. Subsequently, the processing module 310 may continuously (or periodically) search or monitor the information available on the social platform and determines which information is of interest. For example, the processing module 310 may continuously or periodically search or monitor at least one of a particular page or section of the social platform (e.g., one or more pages, sites corresponding to a service provider or entity to which the centralized system 300 belongs or in-charge of monitoring, etc.) for one or more predetermined keywords (e.g., a name of the service provider or entity, nicknames for the entity, a field/category of service related to the service provider or entity, etc.), one or more predetermined mentions (e.g., account belonging to the service provider or entity), one or more hashtag keywords, etc.

A system user, for example, may access the centralized system 300 via the system user terminal 370 and set the predetermined keyword(s) that the system user wants to monitor in the social platform system 350. Additionally or alternatively, the system user may also set the predetermined keyword(s) that are to be excluded from the monitoring. The configuration of the predetermined keyword(s) set by the system user may be stored in the data storage 340 in a keyword configuration profile. The system user is able to select one or more keyword configuration profiles for monitoring the social platform on, for example, a keyword setting GUI generated by the processing module 310. Based on the selected one or more keyword configuration profiles, the processing module 310 continuously or periodically monitors the information (e.g., post, live feed, comments, etc.) available on the social platform system 350 and determines whether or not the monitored information contains any information that may be related to the predetermined keyword(s). If the information posted by the end user contains information that is related to the predetermined keyword(s), the processing module 310 extracts texts from the information (e.g., extract text directly from comments, convert video/audio feed to text description file and extract the text therefrom, etc.) and compares the extracted texts to the predetermined keyword(s) in the selected keyword configuration profile(s).

The processing module 310 may monitor and extract text from the information (e.g., posts/comments) as described above, but is not limited thereto. In another example embodiment, the processing module 310 may simply search for all information (e.g., posts/comments) that includes any keyword(s) among the predetermined keyword(s) and extract or obtain that information for pre-processing. For example, the processing module 310 may simply search for the predetermined keyword(s) in the social platform and pull or obtain all posts including/associating to any of the predetermined keyword(s). Further, the processing module 310 may monitor and extract information in audio and/or video from the social platform. Audio from the audio/video may be converted into text and monitored for the one or more predetermined keywords, mentions, hashtags, etc. Alternatively, audio/video determined to contain the one or more predetermined keywords, mentions, hashtags, etc. (via, for example, waveform comparison, etc.) may be converted into text and further processing may be done thereafter.

In another example embodiment, the system user may also set, via the centralized system 300, a predefined location that the system user wants to monitor and extract (or exclude from monitoring and extracting) from the social platform. For example, the location may be where the post was made, where the end user is determined to be located (via location data from the social platform system 350), or keyword(s) indicating location (e.g., one of various locations of the service which may include city, state, and/or province name, etc.).

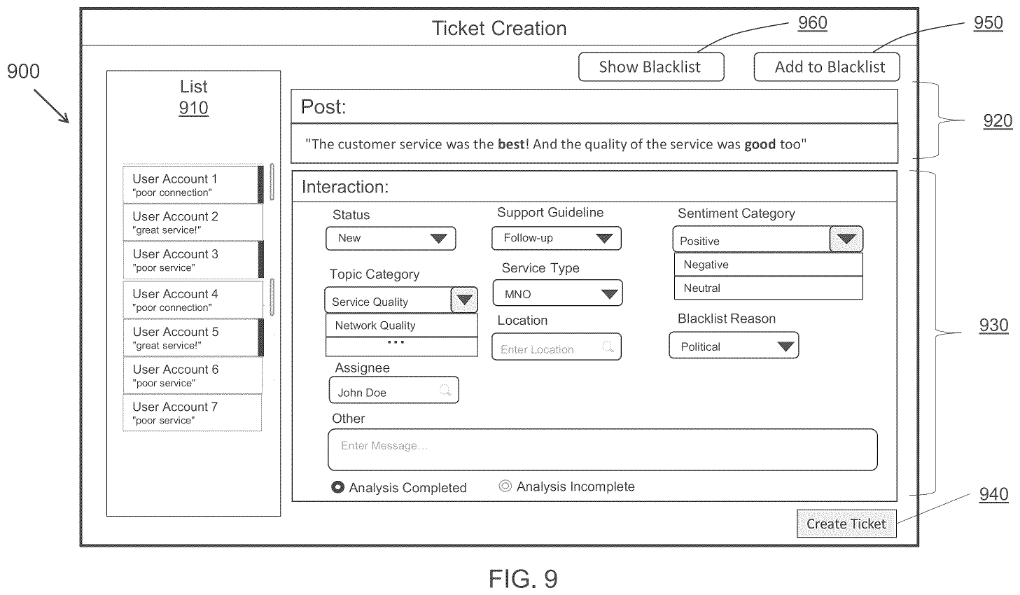

The social platform may be included in or deployed by the social platform system 350 including one or more social platforms. The processing module 310 may pre-process the information retrieved from the social platform and optionally filter the pre-processed information. For instance, the processing module 310 may pre-process the information retrieved from the social platform system 350, based on a blacklist 311 stored in the data storage, so as to identify which information is associated with a user account included in the blacklist. Subsequently, the processing module 310 may generate a list of information (e.g., list 910 of FIG. 9) including the information retrieved from the social platform, wherein the information identified as associated with a user account(s) included in the blacklist may be distinguished from information associated with a user account(s) not included in the blacklist (e.g., information associated with the user account(s) included in the blacklist and information associated with the user account(s) not included in the blacklist may be presented to a user in a different manner). A system user can select information associated with one or more user accounts included in the blacklist, so that the selected information will be filtered or excluded from the information for further processing (e.g., for determining a sentiment category, for creating a ticket, etc.) The pre-processed information that is not filtered or excluded may be used by a sentiment engine module 320 to determine (e.g., based on a Machine Learning/Artificial Intelligent algorithm) a sentiment value associated with the pre-processed information.

The sentiment value may represent a sentiment category in which the extracted and pre-processed information falls under (e.g., a positive, a negative, or a neutral sentiment) and then categorize the extracted and pre-processed information as such. In some embodiments, the sentiment value is determined based on one or more keyword configuration files obtained from the data storage 340. The keyword configuration files may be set by the system user at the same time the predetermined keyword(s) are set or at a different time and stored in the data storage 340 thereafter, or can be pre-generated by some other user and stored in the data storage 340 beforehand. The keyword configuration files may also be the same, different, or inclusive of the predetermined keyword(s) set by the system user. The keyword configuration file may define a plurality of keywords associated with negative sentiments. For example, “bad”, “weak”, “slow”, “expensive”, “disappointed”, “not good”, etc., are keywords associated with negative sentiments and may be referred to as negative keyword(s). The keyword configuration files may also define a plurality of keywords associated with positive sentiments. For example, “good”, “excellent”, “stable”, “fast”, “satisfied”, etc., are keywords associated with positive sentiments and may be referred to as positive keyword(s). Any other words or phrases which fall outside of the scope of the negative sentiments and the positive sentiments may be considered by the sentiment engine module 320 as associated with neutral sentiments.

The sentiment engine module 320 may determine how many negative keyword(s) and/or positive keyword(s) are included in the extracted information or piece of extracted information, and generates a sentiment value. For example, an initial sentiment value is 0. Each of the negative keyword(s) and positive keyword(s) has a respective value, e.g., “bad” has a value of −1, “worst” has a value of −2 (since the degree of the negative sentiment “worst” is higher than the degree of the negative sentiment “bad”), “good” has a value of +1, “best” has a value of +2 (since the degree of the positive sentiment “best” is higher than the degree of the positive sentiment “good”), and the like. The total sentiment value of extracted information (e.g., a post/comment) including keywords “bad” and “worst” will be lower than a post/comment that includes only “bad”. Similarly, a post/comment that comprises “bad” and “best” will have a total sentiment value lower than a post/comment that comprises “best” and “good”. The total sentiment value may be calculated as a summation of the respective sentiment values included in an extracted information (e.g., a post/comment, etc.). In some embodiments, the total sentiment value may be calculated via other mathematical processes, such as a multiplication process or the like.

Accordingly, the sentiment engine module 320 generates a sentiment value that represents the sentiment level of the extracted information or the total sentiment value of the entire pre-processed (and not excluded) information (e.g., the entire post/comment). If the pre-processed (and not excluded) information has a total sentiment value that is negative, the information will be determined as having a negative sentiment. If the pre-processed (and not excluded) information has a total sentiment value that is positive, the information will be determined as having a positive sentiment. If the information has a sentiment value of zero, the system will determine that the information has a neutral sentiment. In some embodiments, if the total sentiment value is below/exceeds a predetermined threshold value (e.g., predetermined by the system user, etc.), the pre-processed (and not excluded) information will be determined as having a negative sentiment, a positive sentiment, or a neutral sentiment. The lower the value of a negative sentiment value, the more negative the information is determined to be (e.g., an information with sentiment value of −10 is determined to be more negative than an information with sentiment value of −1). The higher the value of a positive sentiment value, the more positive the information is determined to be (e.g., an information with sentiment value of +10 is determined to be more positive than an information with sentiment value of +1).

In some example embodiments, negative sentiments with a negative sentiment value lower than a predetermined threshold may be determined as requiring urgent attention and/or set as requiring higher priority to the system user as compared to other negative sentiments with a negative sentiment value that is not lower than the predetermined threshold. In some embodiments, the urgency of negative sentiments may also be determined based on the blacklist. For instance, when two negative sentiments have the same negative sentiment value, the negative sentiment associated with a user account(s) included in the blacklist may be determined as requiring more (or less) urgent attention and/or sent as requiring higher (or lower) priority to the system user as compared another negative sentiment associated with a user account(s) not included in the blacklist, or vice versa. Alternative embodiments or any suitable variation of the above-described example embodiment (e.g., a positive sentiment value below a threshold representing a neutral or a negative sentiment, etc.) should not be excluded from the scope of disclosure. Based on the sentiment level (and similarly, the sentiment value and/or category), the processing module 310 may trigger an action.

For example, if it is determined that the pre-processed (and not excluded) information falls under the negative sentiment category, a message (e.g., in the form of email, SMS, push notification, etc.) may be generated to notify a system user that negative information has been posted on a social platform and investigation of the post is required. The notification is not limited to this and may include other messages and details of the post (e.g., at least one of an identifier of the social platform in the social platform system the user posted the comment on, the keywords found in the comment, the sentiment value determined to be associated with the post, time stamp of the post, other related posts by the same end user that include related information/keywords, etc.). Subsequently, a ticket to be handled by a system user may be generated and presented by the centralized system 300 via, for example, a ticket creation GUI provided by a ticket management module 330. Specifically, the ticket creation GUI may comprise a plurality of input fields to receive inputs from the system user for specifying the ticket.

The ticket creation GUI may also include a graphical representation area (e.g., a list, a post portion, etc.) showing at least a portion of the pre-processed information (e.g., portion of a post which is determined to contain negative information, etc.) and showing the information required for creating a ticket (e.g., the sentiment category, a location of the post or user, blacklist reason, etc.) so as to allow the system user to easily and clearly create a ticket based thereon. In some embodiments, the centralized system 300 may trigger the ticket management module 330 to automatically generate a ticket, in response to the extracted information falling under the negative sentiment category. The ticket may be generated and presented to the system user on a GUI to enable review and editing via the system user terminal 370.

In some embodiments, it is possible that multiple tickets are generated at the same time. The multiple tickets may be generated from the same social platform or different social platforms in the social platform system 350.

In some embodiments, the ticket management module 330 may generate and present the ticket creation GUI to the system user to allow the system user to create a ticket for the social platform information determined as positive or neutral information. Embodiments of the present disclosure are not limited to automatic generation of a ticket. For example, in another example embodiment, the system user is notified of the extracted information and/or the sentiment category, and the system user manually creates the ticket(s).

The ticket will be assigned by the system user (via the ticket creation GUI) to an appropriate handler. The handler/ticket assignee will then review the ticket and determined whether or not it is required to interact with the end user who raised the issue or made the post/comment. If it is determined that it is required to interact with the end user who raised the information, the system user may communicate with the end user via, for example, a GUI. For example, the system user may use the GUI to send a direct message to the end user, replying to the post/comment, etc.

The system user may interact with the end user through a system user terminal 370 via the centralized system 300. The system user may be, for example, an administrator of the service provider, a person in charge of the service associated to the information from the social platform, a customer service agent, or the like. The end user may receive and respond to communication from the system user through a user terminal 360 via the social platform system 350 or any other suitable channels. The system user terminal 370 and the user terminal 360 may correspond to, for example, the first device 110 and/or the second device 130 illustrated in FIG. 1 or device 200 illustrated in FIG. 2. The communication between the system user terminal 370 and the user terminal 360 may be, for example, via direct messaging, reply/comment to a post, etc.

In some embodiments, the processing module 310 may create and use a watchlist to enhance the blacklist 311. The watchlist is based on contents of information posted by a user (e.g., a post, comment, review, etc.) on the social platforms included in the social platform system 350. The processing module 310 retrieves information posted by user accounts (which are not included in the blacklist 311) and processes the information. Upon processing of the information, the processing module 310 may determine whether or not a user should be included in a watchlist. Based on the determination, the user may be added to the watchlist. Then, the system user may further determine whether or not the user in the watchlist should be included in the blacklist 311.

In the same or another example embodiment, the processing module 310 may automatically identify suspect user accounts and add the suspect user accounts into the watchlist. A suspect user account is, for example, a user account potentially posting fake information. The system user may review the user accounts in the watchlist and then determine whether or not to add the user accounts into blacklist 311. Whether or not to include a user account into the watchlist may be based on a suspect level of the information posted by the user.

The suspect level may be determined based on, for example, a comparison between a similarity in user account ID and the user accounts which have been included in the blacklist. In this manner, repeated fake accounts may easily be identified and filtered out before processing. Further, a comparison between the contents of the posted information and actual content may be used to identify accuracy of the information and determine false information. For example, if a user makes a post complaining about network failure in location A, the processing module 310 will check to confirm whether or not there is actually a network failure in location A (e.g., by retrieving ticket database to check whether or not there are any tickets related to network failure in location A, accessing change management system to check whether or not any network changes have been performed in location A for addressing network failure, etc.).

In some embodiments, the processing module 310 compares the posted information taking into consideration the language of the post/location of the user and the content of the information. For example, if the post is related to a service provided in Japan, but the post is written in Chinese or posted by an account in the US (e.g., determined based on a bibliography of the user account, etc.), then the processing module 310 may determine that there is a possibility that the post is inaccurate.

When the information posted by the user account is determined to be inaccurate, the processing module 310 may increase a threshold value indicating a suspect level of the user account, and the user account will be added to the watchlist for the system user to review the user account and potentially include the user account into the blacklist 311. Alternatively, the system user can maintain the user account in the watchlist for future monitoring of the user account or other user accounts. If it is determined that the user account always posts inaccurate information, the processing module 310 may increase the threshold until it exceeds a predetermined threshold and the processing module 310 may further recommend the system user to include the user account in the blacklist 311.

In addition to including user accounts that are possibly posting fake information to the blacklist 311, the watchlist may also be used to include user accounts that may potentially post harmful information in the future. A user may actively post information related to a company, but the posted information may not yet be negative and/or harmful. In that case, although the user's account should not be included in the blacklist 311, it will be useful to include that user's accounts in the watchlist so that the system user can closely monitor the activities of the user account and any other posts made by the user. For example, after the processing module 310 retrieves the information from the user account (i.e., the social platform system 350) and processes the information, if it is determined that the information includes a specific keyword(s) for a predetermined amount of times/instances (e.g., the user account mentioned company A and the competitor company C 10 times in one post, indicating that the user may be comparing company A with company C, etc.), the processing module 310 will add the user account into the watchlist. Alternatively, the processing module 310 may determine the interval between the posting time of the information and add the user account which posted information about the company exceeds a threshold of frequency of posts within a period (e.g., the user account posted an information associating to company A 10 times within 5 minutes, etc.).

In some embodiments, the ticket management module 330 of centralized system 300 may generate and present the ticket creation GUI to the system user to allow the system user to create a ticket for information provided/posted by a user account that the processing module 310 determines should be on the watchlist. Based on the ticket, the system user may analyze the corresponding post or user account and determine if the user account should be moved to the blacklist 311.

In some embodiments, the processing module 310 may also use a trash list to allow the system user to further categorize the retrieved information, so as to control noise in the retrieved information and focus on relevant information. The processing module 310 may add non-informative information (e.g., trash feeds, trash post, etc.) into the trash list. The non-informative information may be, for example, campaign/advertisement, information posted by subsidiary/related companies, etc. This information may not be particularly useful for review. The system user may manually add information into the trash list, for example, by pressing a trash bin button that appears on a GUI of the centralized system 300 for each information. Alternatively, the system user may set a rule via the GUI generated by the processing module 310 (e.g., all information posted by an account which contains a specific keyword, etc.), and the processing module 310 will automatically move the information to the trash list based on the created rule.

In some embodiments, the processing module 310 suggests information to be included in the trash list, based on a determination that a team member of the system user has previously or currently included the same/similar information in the trash list.

The processing module 310 (e.g., processor 220 in FIG. 2), the sentiment engine module 320, and the ticket management module 330 are communicatively coupled to each other, via an API gateway. It is understood, however, that one or more other embodiments are not limited to this configuration. Some modules may be combined or separated into separate modules. For example, the processing module 310 may also function as the sentiment engine module 320. The processing module 310 may be communicatively coupled to one or more system user terminals (e.g., system user terminal 370) and may be communicatively coupled to one or more user terminals (e.g., user terminal 360). Further, the processing module 310 may also be communicatively coupled to the social platform system 350. The social platform system 350 may be communicatively coupled to one or more user terminals (e.g., user terminal 360). The data storage 340 may also be communicatively coupled to the processing module 310 of centralized system 300 and the social platform system 350.

The data from the centralized system 300 (e.g., the pre-processed information from the processing module 310, the sentiment value from the sentiment engine module 320, the sentiment category the information falls under, etc.) may be stored in the data storage 340. The data storage 340 may be internal or external to the centralized system 300 and may be similar to or different from the storage component 240 of FIG. 2. In some embodiments, the data storage 340 comprises multiple data storages.

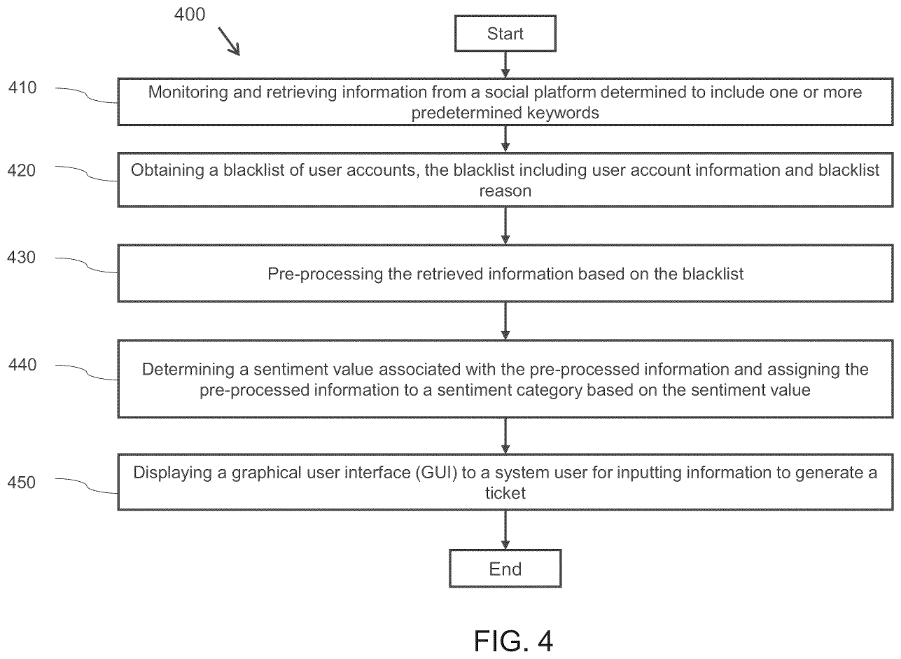

FIG. 4 is an exemplary flowchart illustrating a method 400 for pre-processing information from a social platform, according to an embodiment. The method 400 of FIG. 4 may be performed by the centralized system 300.

In operation 410, one or more social platforms are monitored and information is retrieved therefrom based on one or more predetermined keywords. The information may include, but is not limited to, posts, text extracted from posts, user account information such as username and/or user ID, etc.

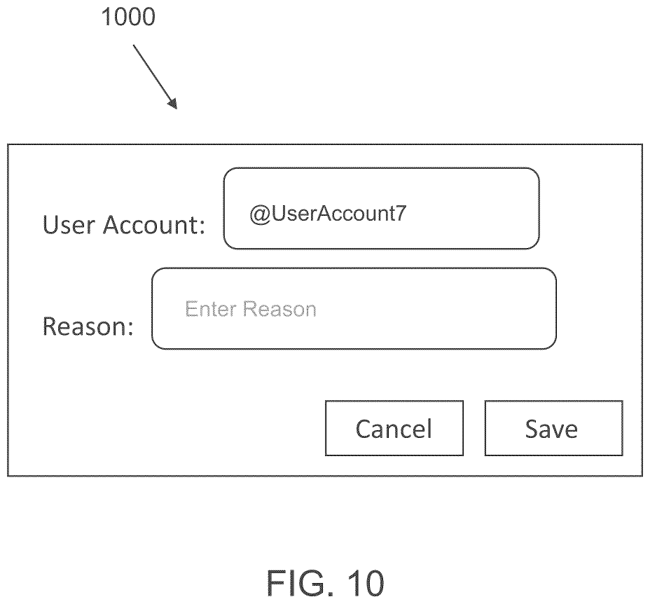

In operation 420, a blacklist of user accounts is obtained, the blacklist including user account information and a blacklist reason(s). For example, in operation 420 (or prior to the method being performed), a user account (e.g., social platform user account) may be selected by a system user and added to the blacklist thereafter. For example, the system user may select and add a user account by entering the user account (or a keyword associated thereto) into a graphical user interface (GUI) (such as shown and described below with reference to FIG. 10). Further, the system user may identify or select the user account with reference to information posted to the social platform by the user account that is included in a list or feed of posts.

In operation 430, the retrieved information is pre-preprocessed and is optionally filtered based on the blacklist. For example, the retrieved information will be distinguished into information associated with a user account(s) included in the blacklist and information associated with a user account(s) not included in the blacklist, wherein said information will be displayed in a list of information (e.g., list 910 of FIG. 9) in a different manner (e.g., information associated with the user account(s) included in the blacklist will be indicated by distinguishing characteristic such as a bolded line, etc.). Subsequently, a system user can easily identify and select information associated with one or more user accounts included in the blacklist, so that the selected information will be filtered and excluded from the information for further processing (e.g., for determining a sentiment value and sentiment category, for creating a ticket, etc.) The list may be populated with information (e.g., posts) that are searched or obtained based on the one or more predetermined keywords (e.g., product name, company name, various spellings/misspellings and/or language variations of product/company name, company social platform account identifier, name of employee, owner, chairperson, etc., of company, social platform account identifier of employee, owner, chairperson, etc., of company, etc.)

In operation 440, a sentiment value is determined for the pre-processed (and not excluded) information and the pre-processed information is assigned to a sentiment category based on the sentiment value.

In operation 450, a GUI is displayed to the system user for generating a ticket. For example, the system user, based on the retrieved information and the blacklist, inputs information via the GUI to generate a ticket. Further, the user accounts included in the blacklist may be distinguishably displayed on the GUI.

Although FIG. 4 shows example operations of the method, in some implementations, the method may include additional operations, fewer operations, different operations, or differently arranged operations than those depicted in FIG. 4. Additionally, or alternatively, two or more of the operations of the method may be performed in parallel or combined. For example, according to another embodiment, the generating and use of the watchlist may be included (or omitted).

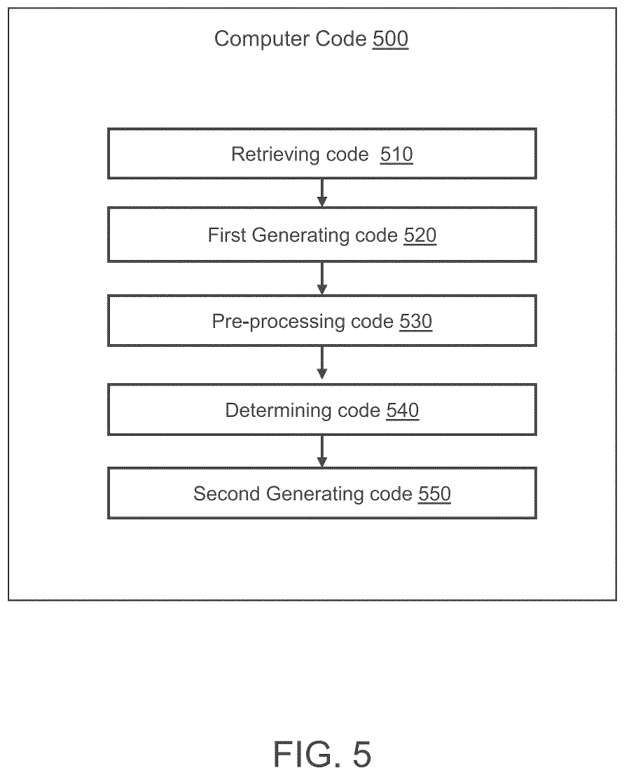

FIG. 5 is a block diagram of an example of computer code pre-processing information from a social platform according to one or more embodiments. According to embodiments of the present disclosure, an apparatus/device including at least one processor with memory storing computer code may be provided. The computer code may be configured to, when executed by the at least one processor, perform any number of aspects of the present disclosure.

As shown in FIG. 5, the computer code 500 may include retrieving code 510, first generating code 520, pre-processing code 530, determining code 540, and second generating code 550.

The retrieving code 510 is configured to cause the at least one processor to retrieve information from a social platform. Here, the retrieving code causes the at least one processor to retrieve the information from the social platform based on one or more predetermined keywords, as described above.

The first generating code 520 is configured to cause the at least one processor to generate a blacklist of user accounts, the blacklist including user account information and blacklist reason.

The pre-processing code 530 is configured to cause the at least one processor to process the retrieved information, based on the blacklist. For example, the pre-processing code 530 is configured to (1) distinguish information associated with a user account(s) included in the blacklist and information associated with a user account(s) not included in the blacklist, and (2) optionally receive a user's selection of information and filter out the selected information from among the retrieved information.

The determining code 540 is configured to cause the at least one processor to determine a sentiment value associated with the pre-processed (and not excluded) information and assign the pre-processed information to a sentiment category based on the sentiment value.

The second generating code 550 is configured to cause the at least one processor to generate a GUI displayed to the system user, wherein the system user, based on the retrieved information and the blacklist, inputs information via the GUI to generate a ticket. The user accounts included in the blacklist are distinguishably displayed on the GUI. For example, the information associated with the blacklisted accounts may be displayed on a feed of posts but displayed distinguishably from pre-processed information that is not associated with a blacklisted account.

Although FIG. 5 shows example blocks of the computer code 500 of a system or device according to embodiments, in some implementations, the system may include additional blocks, fewer blocks, different blocks, or differently arranged blocks than those depicted in FIG. 5. Additionally, or alternatively, two or more of the blocks of the system may be combined. In other words, while FIG. 5 shows distinct blocks of code, the various code instructions need not be distinct and could be intermingled.

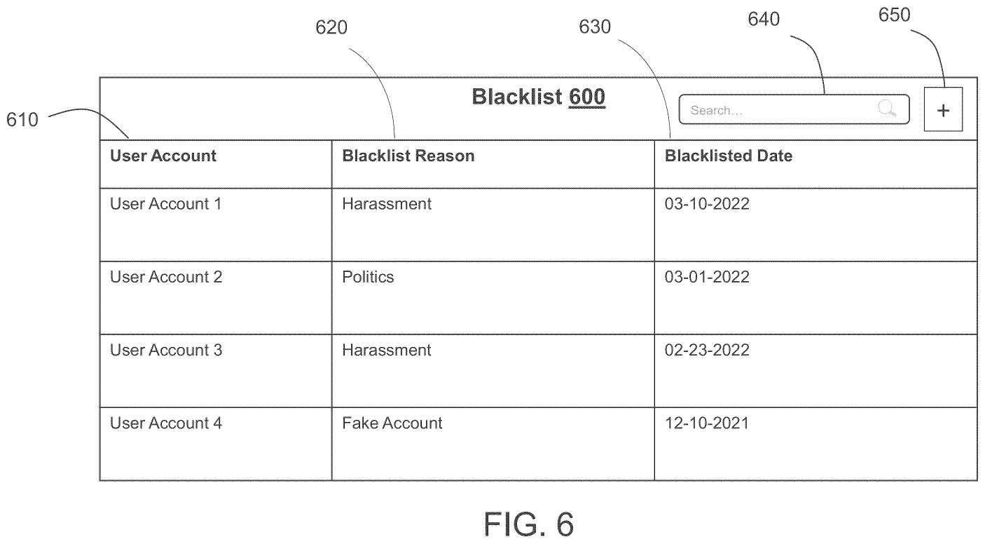

FIG. 6 is an example illustration of a blacklist 600 according to some embodiments. The blacklist 600 may be displayed to an authorized user (e.g., system user) via a GUI. For example, the blacklist 600 may be displayed in response to a user selection to display the blacklist (e.g., a selection on a menu or on an icon for displaying the blacklist on a different screen or GUI, such as the icon 960 included in the ticket creation GUI 900 shown in FIG. 9). As shown in FIG. 6, the blacklist 600 includes user accounts 610, a blacklist reason 620, and a blacklisted date 630 (i.e., when the user account was blacklisted). The blacklist 600 may be configured to display additional information such as a post(s) and/or keyword(s) that caused the user account to be added to the blacklist 600. A system user may make a search for a desired keyword(s), user account, or the like, from the blacklist 600 using an input search field 640. In the same or another embodiment, the system user may delete or edit one or more of the user accounts 610. The system user may also select an option to select all the user accounts 610 in the blacklist 600 to be deleted or edited.

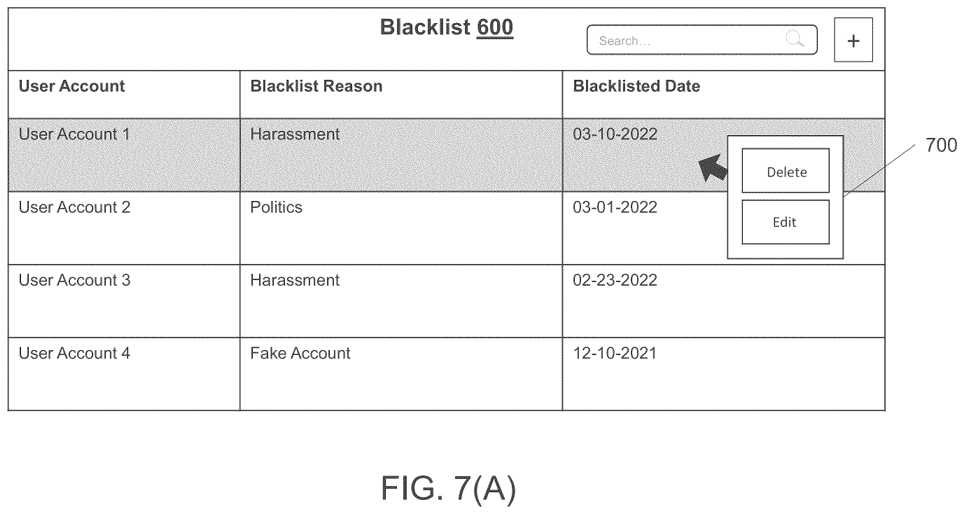

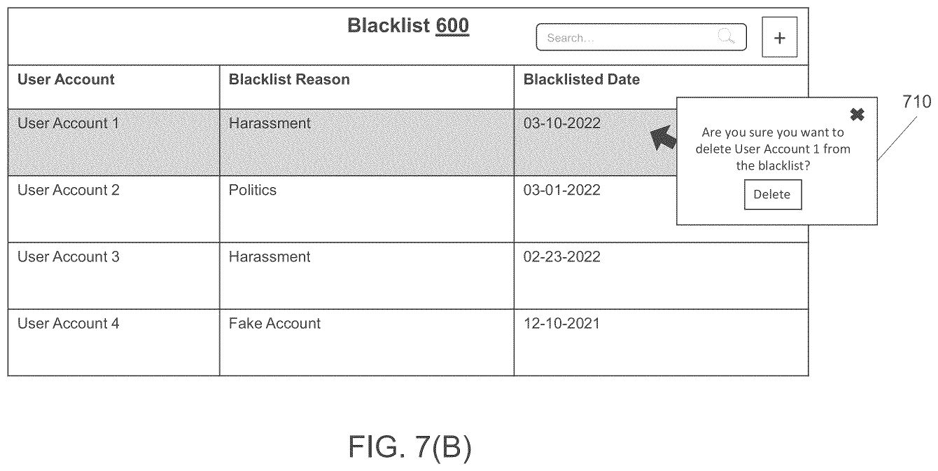

As shown in FIG. (7A), the system user may select (e.g., by hovering, clicking on a dedicated button/icon on the user terminal, or performing another predetermined operation) a user account in the blacklist 600 to cause the display of a pop-up 700 (or an icon or the like). The system user may select from a list of options on the pop-up 700 to perform an action of, for example, adding and/or removing an user account for the blacklist 600. For example, as shown in FIG. 7(A), the list of options includes a delete option and an edit option. The system user may select the delete option, (or perform some other predetermined operation) to initiate the deletion of the selected user account from the blacklist. Alternatively, the system user may select edit option, (or perform some other predetermined operation) to make changes to the information corresponding to an existing blacklisted user account.

Upon selecting the delete option, another pop-up 710 may appear on the GUI requiring confirmation from the system user before performing the deletion of a user account from the blacklist. As shown in FIG. 7(B), a confirmation message of “Are you sure you want to delete User Account 1 from the blacklist?”, along with a “delete” button, is displayed on the GUI. The system user may confirm the desired deletion of the user account by, for example, pressing the “Delete” button illustrated in FIG. 7(B) or cancel the deletion of the user account by, for example, closing the pop-up by selecting the “x” icon displayed in the pop-up window. Other operations may also be performed to provide confirmation of the desired deletion, such as pressing a “YES” or “NO” button displayed on the GUI or another variation of similar operations.

Upon selecting the edit option, the system user may be prompted with a pop-up window including input fields corresponding to the information displayed in the blacklist (i.e., the user account 610, the blacklist reason 620, and the blacklisted date 630). The system user may make any necessary changes and further save the changes.

In one or more embodiments, in the list of options illustrated in FIG. 7(A), the GUI may include a selection option for displaying a history log. The history log may include, but is not limited to, a record of changes/updates made in the blacklist, a record of changes/updates a specified blacklisted user account, information such as when (e.g., time, date, number of days since the user account was added, etc.) a user account was added to the blacklist, etc. The history log may be stored in the data storage 340 so that history information for all system users contribute to the history log.

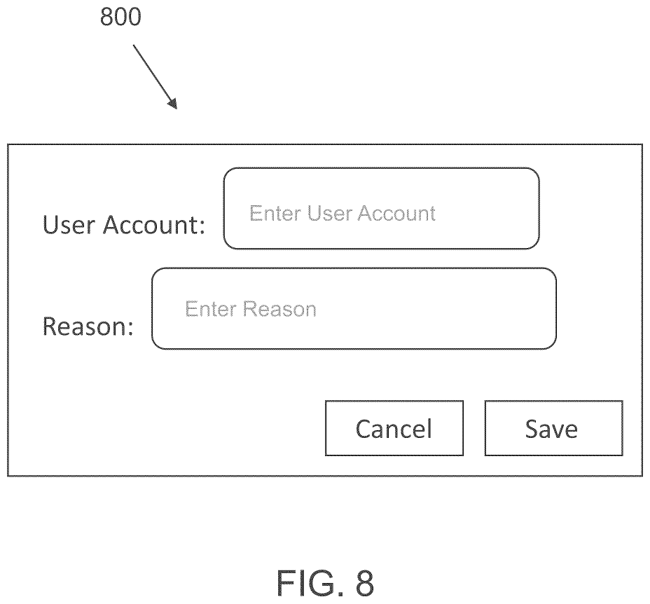

As shown in FIG. 6, user accounts may also be added to the blacklist 600. In one example embodiment, the system user selects an add icon 650 displayed on the blacklist 600 to add a user account to the blacklist. Upon selecting the add icon 650, an add blacklist account pop-up window including a plurality of input fields, to receive inputs from the system user for specifying relating details for the addition of the user account, may appear on the GUI. An example of an add blacklist account pop-up window is illustrated in FIG. 8. As shown in FIG. 8, the add blacklist account pop-up window 800 includes input fields for specifying a user account and a reason for adding the user account to the blacklist. The system user may input the reason for including the user account in the blacklist via the reason input field. It is understood that embodiments are not limited to this. One or more input fields may be included or removed from the example illustration of FIG. 8. Once the input fields are filled, the system user may select a button (e.g., Save, Register, Done, Add, etc.) to add the user account to the blacklist. As shown in FIG. 8, the system user may select a “Save” button to add a user account to the blacklist 600 or a “Cancel” button to close out of the add blacklist account pop-up window 800. If the system user decides to cancel the process of adding the user account to the blacklist (e.g., by pressing the “Close” button), the GUI may return back to the blacklist view (as shown in FIG. 6), a previously display, or another predetermined display. Based on the system user selecting the “Save” button, one or more additional items (or fields, metadata, etc.) may be automatically obtained and saved (e.g., stored in the data storage 340) in association with the user account added to the blacklist. For example, at least one of the date/time the user account is added to the blacklist, the system user account identifier (or system user name) of the system user that added the user account to the blacklist, etc.

In some embodiments, once the system user selects the “Save” button, a notification will appear (e.g., as a pop-up message, or the like) confirming that the account has been successfully added to the blacklist. In some embodiments, if a first system user, who is different from a second system user who added a user account to the blacklist, deletes the user account from the blacklist, the second system user may be notified that the first system user has deleted the user account from the blacklist.

FIG. 9 is a diagram illustrating an example of a GUI for creating a ticket (hereafter “ticket creation GUI 900”), according to an embodiment.

As shown in FIG. 9, the ticket creation GUI 900 may include information retrieved from the social platform and input fields for specifying ticket parameters. The ticket creation GUI may include a list 910 comprising information retrieved from the social platform system 350. The list 910 may include a full post, full comments, and information on an end user such as a user name, user ID, or other user account information. The information is not limited to the above-described examples, and may include other information. In some example embodiments, the list 910 may be customized by the system user to include information desired by the system user, and/or configure the presentation of the list 910 according to keyword(s), regions, user groups, and/or any other suitable factors for categorizing the information. Posts and/or usernames of user accounts included in the blacklist may be emphasized (e.g., highlighted, distinctive shading, bolded, underlined, etc.) in the list 910. As shown in FIG. 9, posts made by user accounts included in the blacklist (i.e., User Account 1, User Account 3, and User Account 5) are indicated by a bolded line (or some other distinguishing characteristic, such as a line with a predetermined color) and are distinguishable from the other posts made by user accounts that are not included in the blacklist. Thus, the system user is easily able to distinguish between posts made by blacklisted accounts and other user account when creating a ticket.

The system user may select a post from the list 910 to further create a ticket. The selected post 920 is separately displayed on the GUI. The selected post 920 may also include detail account information of the end user such as the username and user ID. In one or more embodiments, keyword(s) or parts of the selected post 920 that are suspected to be potential reason(s) for blacklisting an account may be emphasized (e.g., highlighted, bold, underlined, etc.) in the selected post 920. Information or keyword(s) which resulted in a particular sentiment category may also be included or emphasized (e.g., highlighted, bold, underlined, etc.) in the selected post 920, in a different manner as the potential reason(s) for blacklisting the account (e.g., the keyword(s) which resulted in the particular sentiment category will be emphasized in a first color, and the reason(s) for blacklisting the account will be emphasized in a second color different from the first color, etc.). As shown in FIG. 9, the keyword(s) (e.g., “best” and “good”) are in bold and distinguishable in the selected post 920.

The system user may add a user account to the blacklist 600 through the ticket creation GUI 900. The system user may select an add icon 950 to add the user account relating to the selected post 920 to the blacklist 600. Upon selecting the add icon 950, an add blacklist account pop-up window including a plurality of input fields (for receiving inputs from the system user for specifying relating details for the addition of the user account) may appear on the ticket creation GUI 900. One or more input fields (e.g., user account information) may be auto-filled based on the selected post and the corresponding user account information. The system user may change or update one or more of the auto-filled input fields if necessary. An example of an add blacklist account pop-up window, displayed from the ticket creation GUI 900, is described below with reference to FIG. 10.

The interaction section 930 of the ticket creation GUI 900 may include a plurality of input fields to allow the system user to view and input/edit the ticket parameters which may be required for creating a ticket. The parameters may include a status, a support guideline, a sentiment category, a topic category, a service type, a location, an assignee (i.e., a system user assigned to handle the ticket), an assigned workgroup, other related keywords or labels, and any other suitable parameters. The system user may also input any other information or message in a message box included in the interactions section 930 (labeled “Other” in FIG. 9).

In some embodiments, the topic category is the category of the potential issue being raised in the post/comment. For example, the potential issue may be related to network quality, service quality, etc. It is understandable that the topic category is not limited to potential issue, but can also be any positive or neutral topics (e.g., top customer service, average pricing, etc.). One or more of the topic category, the sentiment category, the status, the support guideline, and the service type input windows may be pre-filled with parameters recommended by the centralized system 300. In the example of FIG. 9, the centralized system 300 determines that the post is related to service quality and the post falls under positive sentiment category, and thus pre-fills the input window of topic category with a parameter of “Service Quality” and pre-fills the input window of sentiment category with a parameter of “Positive”. If the system user, based on analysis of the selected post 920, determines one or more of the ticket parameters should be changed, the system user may have the authority to change the system recommended parameters by selecting the arrow by/associated with the ticket parameter the system user would like to change. The arrow will display a drop-down menu associated with the respective ticket parameter. An exemplary drop-down menu associated with example selection options for the sentiment category and the topic category ticket parameters are displayed in FIG. 9. Additionally, although FIG. 9 illustrated that the system user is prompted to enter the location, in another embodiment, the location parameter may also be auto-filled by the centralized system 300 based on, for example, the information from the social platform system 350. In FIG. 9, the blacklist reason is political. The blacklist reason input field may be manually filled by the system user. In some embodiments, the blacklist reason input field is auto-filled with a recommendation from the processing module 310 and may be updated by the system user based on an analysis of the post and/or user account.

In the example of FIG. 9, the assignee is a user named John Doe. The assignee may be associated with the topic category (e.g., when the topic category is “Service Quality”, the assignee may be a user responsible of handling tasks related to service quality, etc.) The assignee may be the same or different from the system user creating the ticket. The assignee may also indicate if an analysis of the post or user account is complete or incomplete by selecting, for example, a button displayed on the ticket creation GUI 900. As shown in FIG. 9, the assignee has selected the “Analysis Complete” button at the bottom of the display. The selection options are not limited to this. It is understood that the ticket creation GUI 900 may alternatively display selection options such as pending analysis, not started, in progress, etc.

Based on the information on the ticket creation GUI 900, the system user may trigger the creation of a new ticket by performing a predetermined operation such as clicking on a functional element 940 (e.g., a button, etc.). As shown in FIG. 9, an example of such a function element is labeled “Create Ticket”. Once the ticket is created, the ticket may be stored and presented to the system user in another GUI displaying a list of created tickets. In some example embodiments, the ticket is created by the centralized system 300. In another example embodiment, when the system user triggers the dedicated functional element 940, the centralized system 300 will contact a ticket creation system (e.g., via an API gateway, etc.) and the ticket creation system will generate and provide the created ticket to the centralized system 300. In some embodiments, the assignee is pre-assigned by the centralized system 300 (e.g., based on the status, topic category, sentiment category, service type, and/or location). In some embodiments, the assignee is manually assigned by the system user who creates or is creating the ticket. In another example embodiment, the ticket may be assigned (e.g., by the system user, the centralized system, the ticket creation system) to an appropriate handler or system user after the ticket is created. In some embodiments, the involvement of the system user is not required. Once the centralized system determines that retrieved information, for example, should be included in the watchlist, the centralized system may automatically create (e.g., with an internal or external ticket creation system) an appropriate ticket and forward the ticket to the appropriate handler or system user. In some embodiments, when the centralized system 300 detects that one system user is currently accessing the ticket creation GUI 900 for specific information (e.g., User Account A, post B, etc.), the centralized system 300 will disable other system users from creating a ticket for the same information at the same time (e.g., lock the ticket creation features on the ticket creation GUI 900, disable the access of other system users to the ticket creation GUI 900, etc.), so as to avoid multiple tickets being created for the same objective. In some embodiments, before creating a ticket, the centralized system 300 will present a list of created ticket(s) associated with the information, so that the system user can review the associated ticket(s) before creating a new ticket. In some embodiments, after the system user triggers an interactive element for creating the ticket (e.g., by clicking on a “Create Ticket” button), the centralized system 300 checks whether or not a ticket with the same parameters (e.g., status, topic category, sentiment category, service type, location, and/or Assignee) has already created for the same information, and present a notification (e.g., “Ticket with the same parameters have been created for this post”, etc.) to notify the system user before actually creating a new ticket based on the parameters selected by the system user.

FIG. 10 is an example illustration of an add blacklist account pop-up window 1000, displayed when the system user wants to add a user account to the blacklist from the ticket creation GUI 900 (i.e., when the add icon 950 is selected). As shown in FIG. 10, the add blacklist account pop-up window 1000 includes input fields for user account and reason. The user account input field is automatically filled based on the selected post 920 (e.g., if the selected post 920 is associated with a user account 7, user account 7 will be automatically filled in the user account input field). The system user need only manually fill the reason input field and select the “Save” button to add the user account (for example, “@UserAccount7” as shown in FIG. 10) to the blacklist. As similarly described regarding the add blacklist account pop-up window 800, the system user may also select the “Cancel” button to close out of the add blacklist account pop-up window 1000. Other features described with reference to the add blacklist account pop-up window 800 may also be applied to the add blacklist account pop-up window 1000.

In another example embodiment, all the input fields may be auto-filled by the processing module 310 and the system user may update or edit one or more of the input fields by selecting, for example, a drop down menu or the link.

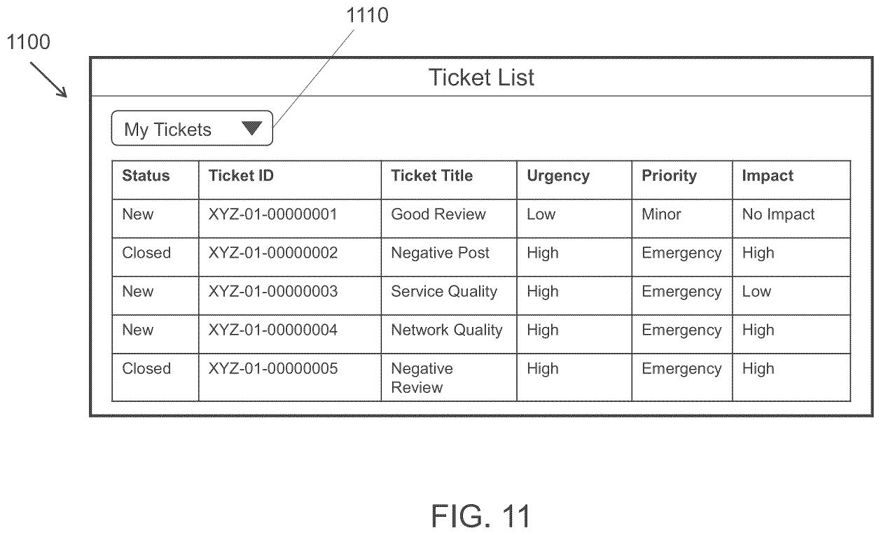

FIG. 11 is an example GUI illustrating the list of created tickets (hereafter “ticket list 1100”), according to an embodiment.

The ticket list 1100 is a list of all previously and newly created tickets. Each ticket in the ticket list 800 will include associated parameters including, but is not limited to, ticket status, ticket ID, ticket title, urgency, priority, impact, ticket family (not depicted), domain (not depicted), and other suitable parameters for providing a summary of the ticket to the system user or the assignee. The new ticket created (via the ticket creation GUI 900) may be displayed at the top of the ticket list 1100 with other previously created tickets following in the list (i.e., tickets are displayed in order of most recently created). In another example embodiment, the tickets may be displayed in order of urgency, priority, impact, topic category, or the like. Ticket parameters, such as urgency, priority, and impact, may be determined by the centralized system 300 based on, for example, the sentiment value and/or the topic category of the information.

In some embodiments, the ticket list 1100 also includes an assignee selection field 1110. The system user may use this field to filter through all tickets based on assignee. In the example of FIG. 11, the ticket list is a view of tickets only assigned to the current system user. One or more of the ticket parameters may also include hyperlinks that, when selected, display or present (e.g., as a pop-up, new window/GUI, etc.) more detailed information relating to the ticket.

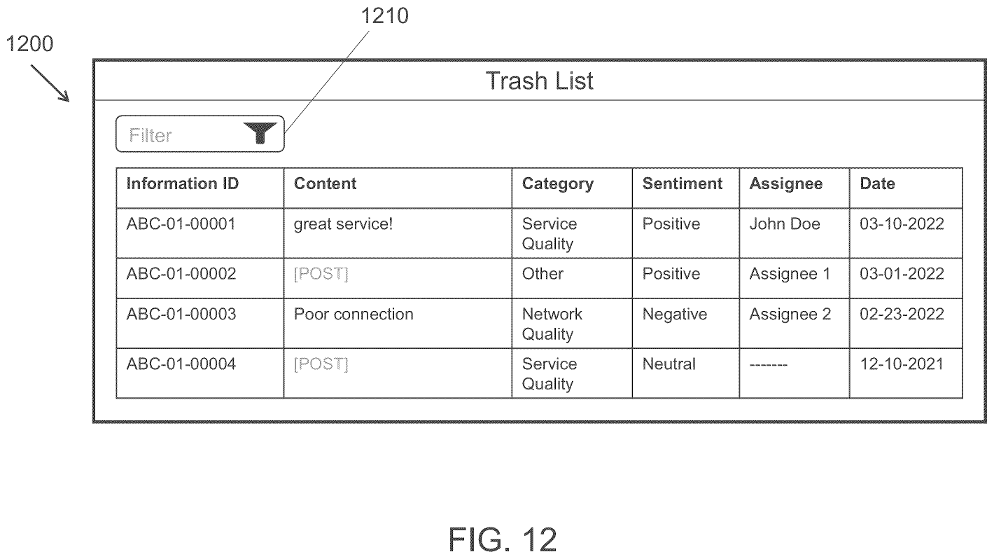

FIG. 12 is an example GUI illustrating a trash list (hereafter “trash list 1200”), according to an embodiment.

The trash list 1200 is a list of all previously and newly added information to the trash list. Each entry in the trash list 1200 may include associated parameters including, but is not limited to, an information identification (ID), contents of the post or information, a topic category, a sentiment category, an assignee (i.e., the system user that added the information to the trash list), assignee workgroup (not depicted), a time of the post/information (not depicted), a date (i.e., when the information was posted or when the information was added to the trash list, a location (not depicted), and other suitable parameters for providing a summary of the information indicated as trash by the system user or the assignee. Information newly added to the trash list 1200 may be displayed at the top of the trash list 1200 with other previously added information following in the list (i.e., information is displayed in order of most recently added).

In some embodiments, the trash list 1200 may also include a filtering field 1210. The system user may use this field to filter through all the information in the trash list 1200 based on, for example, assignee, sentiment category, or other parameter. One or more of the parameters may also include hyperlinks that, when selected, display or present (e.g., as a pop-up, new window/GUI, etc.) more detailed information relating to the user account, the post/information, etc.

Although FIGS. 6-12 show examples of GUIs, in some implementations, the GUI may include additional items, fewer items, different items, or differently arranged items than those depicted in FIGS. 6-12. Additionally, or alternatively, the operation and/or functionality of two or more of the items of the GUIs may be combined or different from the above detailed description. The GUIs illustrated in FIGS. 6-12 may be displayed to the system user via the device 200 or the like.

The foregoing disclosure provides illustrations and descriptions, but is not intended to be exhaustive or to limit the implementations to the precise form disclosed. Modifications and variations are possible in light of the above disclosure or may be acquired from practice of the implementations.

Some embodiments may relate to a system including at least one memory configured to store computer program code and at least one processor configured to access the computer program code and operate as instructed by the computer program code, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, software instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer readable media according to various embodiments. In this regard, each block in the block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the figures. In some alternative implementations, the functions noted in the blocks may occur out of the order noted in the figures. For example, two blocks shown in succession may, in fact, be executed concurrently or substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts or carry out combinations of special purpose hardware and computer instructions.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems, apparatuses, and/or methods were described herein without reference to specific software code—it being understood that software and hardware may be designed to implement the systems, apparatuses, and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for pre-processing information, performed by at least one processor and comprising:
retrieving information from a social platform based on predetermined keywords defined by a system user;
obtaining a blacklist of user accounts, the blacklist including user account information and a blacklist reason for adding the user account information to the blacklist;
pre-processing the retrieved information, based on the blacklist;
determining a sentiment value associated with the pre-processed information and assigning the pre-processed information to a sentiment category based on the sentiment value; and
displaying a first graphical user interface (GUI) for receiving user input information to generate a ticket for the pre-processed information,
wherein retrieved information associated with the user account information included in the blacklist are distinguishably displayed.

2. The method of claim 1, wherein the pre-processing comprises:
determining, from the retrieved information and based on the blacklist, information associated with a user account included in the blacklist;
generating a list presenting the retrieved information, wherein the information associated with the user account included in the blacklist and the information associated with a user account not included in the blacklist are presented in a different manner;
receiving a user input for selecting one or more information from the list, wherein the selected information comprises the information associated with the user account included in the blacklist; and
filtering out the selected information so as to be excluded from the determining the sentiment value.

3. The method of claim 1, further comprising:
displaying a second GUI for adding a user account to the blacklist, the second GUI including a first input field for user account information and a second input field for blacklist reason.

4. The method of claim 3, wherein the first input field is auto-filled.

5. The method of claim 1, further comprising:
generating a watchlist;
determining if a user account is to be included in the watchlist based on a suspect level determined according to an analysis of information posted by the user account to the social platform; and
moving the user account from the watchlist to the blacklist based on a user input to move the user account.

6. The method of claim 3, further comprising receiving a user input, via the second GUI, to delete a user account from the blacklist.

7. The method of claim 1, further comprising generating a trash list and adding information determined to be non-informative to the trash list based on a rule set by the system user, wherein the information is added to the trash list based on information previously added to the trash list.

8. A apparatus for pre-processing information, the apparatus comprising:
at least one memory configured to store program code; and
at least one processor configured to read the program code and operate as instructed by the program code to:
retrieve information from a social platform based on predetermined keywords defined by a system user;
obtain a blacklist of user accounts, the blacklist including user account information and a blacklist reason for adding the user account information to the blacklist;
pre-process the retrieved information, based on the blacklist;
determine a sentiment value associated with the pre-processed information and assign the pre-processed information to a sentiment category based on the sentiment value; and
display first a graphical user interface (GUI) for receiving user input information to generate a ticket for the pre-processed information,
wherein retrieved information associated with the user account information included in the blacklist are distinguishably displayed.

9. The apparatus of claim 8, wherein the at least one processor is configured to read the program code and operate as instructed by the program code to pre-process the retrieved information by:
determining, from the retrieved information and based on the blacklist, information associated with a user account included in the blacklist;
generating a list presenting the retrieved information, wherein the information associated with the user account included in the blacklist and the information associated with a user account not included in the blacklist are presented in a different manner;
receiving a user input for selecting one or more information from the list, wherein the selected information comprises the information associated with the user account included in the blacklist; and
filtering out the selected information so as to be excluded from determining the sentiment value.

10. The apparatus of claim 8, wherein the at least one processor is configured to read the program code and operate as instructed by the program code to:
display a second GUI for adding a user account to the blacklist, the second GUI including a first input field for user account information and a second input field for blacklist reason.

11. The apparatus of claim 10, wherein the first input field is auto-filled.

12. The apparatus of claim 8, wherein the at least one processor is configured to read the program code and operate as instructed by the program code to:
generate a watchlist;
determine if a user account is to be included in the watchlist based on a suspect level determined according to an analysis of information posted by the user account to the social platform; and
move the user account from the watchlist to the blacklist based on a user input to move the user account.

13. The apparatus of claim 10, wherein the at least one processor is configured to read the program code and operate as instructed by the program code to receive a user input, via the second GUI, to delete a user account from the blacklist.

14. The apparatus of claim 8, wherein the at least one processor is configured to read the program code and operate as instructed by the program code to:
generate a trash list and add information determined to be non-informative to the trash list based on a rule set by the system user or information previously added to the trash list.

15. A non-transitory computer readable medium storing instructions that, when executed by at least one processor of an apparatus for pre-processing information storing instructions, cause the at least one processor to:
retrieve information from a social platform based on predetermined keywords defined by a system user;
obtain a blacklist of user accounts, the blacklist including user account information and a blacklist reason for adding the user account information to the blacklist;
pre-process the retrieved information, based on the blacklist;
determine a sentiment value associated with the pre-processed information and assign the pre-processed information to a sentiment category based on the sentiment value; and
display a graphical user interface (GUI) for receiving user input information to generate a ticket,
wherein retrieved information associated with the user account information included in the blacklist are distinguishably displayed.

16. The non-transitory computer readable medium of claim 15, wherein the instructions further cause the at least one processor to pre-process the retrieved information by:
determining, from the retrieved information and based on the blacklist, information associated with a user account included in the blacklist;
generating a list presenting the retrieved information, wherein the information associated with the user account included in the blacklist and the information associated with a user account not included in the blacklist are presented in a different manner;
receiving a user input for selecting one or more information from the list, wherein the selected information comprises the information associated with the user account included in the blacklist; and
filtering out the selected information so as to be excluded from the determining the sentiment value.

17. The non-transitory computer readable medium of claim 15, wherein the instructions further cause the at least one processor to display a second GUI for adding a user account to the blacklist, the second GUI including a first input field for user account information and a second input field for blacklist reason.

18. The non-transitory computer readable medium of claim 15, wherein the instructions further cause the at least one processor to delete a user account from the blacklist based on a user input, received via the second GUI, to delete the user account from the blacklist.

19. The non-transitory computer readable medium of claim 15, wherein the instructions further cause the at least one processor to:
generate a watchlist;
determine if a user account is to be included in the watchlist based on a suspect level determined according to an analysis of information posted by the user account to the social platform; and
move the user account from the watchlist to the blacklist based on a user input to move the user account.

20. The non-transitory computer readable medium of claim 15, wherein the instructions further cause the at least one processor to:
generate a trash list and add information determined to be non-informative to the trash list based on a rule set by the system user or information previously added to the trash list.
